(19) United States
(12) Patent Application Publication
(10) Pub. No.: US 2023/0252548 A1
(43) Pub. Date: Aug. 10, 2023

(54) RECOMMENDATION DEVICE, RECOMMENDATION SYSTEM, RECOMMENDATION METHOD, AND NON-TRANSITORY COMPUTER-READABLE MEDIUM STORING RECOMMENDATION PROGRAM

(71) Applicant: NEC Corporation, Minato-ku, Tokyo (JP)

(72) Inventor: Nobuaki KAWASE, Tokyo (JP)

(73) Assignee: NEC Corporation, Minato-ku, Tokyo (JP)

(21) Appl. No.: 18/014,606

(22) PCT Filed: Jul. 10, 2020
(86) PCT No.: PCT/JP2020/027004

§ 371 Date: Jan. 5, 2023

(51) Int. Cl. G06Q 30/0601; G06Q 20/40; G06Q 30/0226

(52) U.S. Cl. CPC G06Q 30/0631; G06Q 20/40145; G06Q 30/0226

(57) ABSTRACT

A recommendation device (100) includes: a biometric information acquisition unit (112) that acquires biometric information included in a captured image captured by a predetermined imaging device; an authentication request unit (114) that causes an authentication device (200) that stores biometric information of a plurality of users to perform personal authentication for the acquired biometric information; a purchase history acquisition unit (115) that acquires, in a case where the personal authentication has succeeded, a purchase history of a user who has succeeded in the personal authentication at a predetermined shop; an estimation unit (116) that estimates a purchase tendency based on the purchase history; a selection unit (117) that selects recommendation information based on the purchase tendency; and an output unit (118) that outputs the selected recommendation information to a predetermined display terminal.

### TECHNICAL FIELD

The present invention relates to a recommendation device, a recommendation system, a recommendation method, and a non-transitory computer-readable medium storing a recommendation program, and more particularly, to a recommendation device, a recommendation system, a recommendation method, and a non-transitory computer-readable medium storing a recommendation program for providing recommendation information to a user.

### BACKGROUND ART

Patent Literature 1 discloses a technology of detecting a visit a customer (user) to a store by face authentication, and outputting benefit information derived from purchase history information of the customer to an information terminal possessed by the customer when customer service is necessary.

### CITATION LIST

### Patent Literature

Patent Literature 1: Japanese Unexamined Patent Application Publication No. 2018-045430

### SUMMARY OF INVENTION

### Technical Problem

However, appropriate benefit information differs depending on a timing at which the user visits the store. Therefore, the technology according to Patent Literature 1 has a problem that recommendation accuracy is insufficient.

The present disclosure has been made to solve such a problem, and an object of the present disclosure is to provide a recommendation device, a recommendation system, a recommendation method, and a non-transitory computer-readable medium storing a recommendation program for providing appropriate recommendation information to a user.

### Solution to Problem

A recommendation device according to the present disclosure includes: biometric information acquisition means for acquiring biometric information included in a captured image captured by a predetermined imaging device; authentication request means for causing an authentication device that stores biometric information of a plurality of users to perform personal authentication for the acquired biometric information; purchase history acquisition means for acquiring, in a case where the personal authentication has succeeded, a purchase history of a user who has succeeded in the personal authentication at a predetermined shop; estimation means for estimating a purchase tendency based on the purchase history; selection means for selecting recommendation information based on the purchase tendency; and output means for outputting the selected recommendation information to a predetermined display terminal.

A recommendation system according to the present disclosure includes: an imaging device that captures an image including biometric information of a predetermined user; a recommendation device that is configured to perform communication with the imaging device; and an authentication device that stores the biometric information of the user and is configured to perform communication with the recommendation device, in which the recommendation device includes: biometric information acquisition means for acquiring biometric information included in a captured image captured by the imaging device; authentication request means for causing the authentication device to perform personal authentication for the acquired biometric information; purchase history acquisition means for acquiring, in a case where the personal authentication has succeeded, a purchase history of a user who has succeeded in the personal authentication at a predetermined shop; estimation means for estimating a purchase tendency based on the purchase history; selection means for selecting recommendation information based on the purchase tendency; and output means for outputting the selected recommendation information to a predetermined display terminal.

A recommendation method according to the present disclosure performed by a computer includes: acquiring biometric information included in a captured image captured by a predetermined imaging device; causing an authentication device that stores biometric information of a plurality of users to perform personal authentication for the acquired biometric information; acquiring, in a case where the personal authentication has succeeded, a purchase history of a user who has succeeded in the personal authentication at a predetermined shop; estimating a purchase tendency based on the purchase history; selecting recommendation information based on the purchase tendency; and outputting the selected recommendation information to a predetermined display terminal.

A non-transitory computer-readable medium according to the present disclosure records a program for performing: acquiring biometric information included in a captured image captured by a predetermined imaging device; causing an authentication device that stores biometric information of a plurality of users to perform personal authentication for the acquired biometric information; acquiring, in a case where the personal authentication has succeeded, a purchase history of a user who has succeeded in the personal authentication at a predetermined shop; estimating a purchase tendency based on the purchase history; selecting recommendation information based on the purchase tendency; and outputting the selected recommendation information to a predetermined display terminal.

A recommendation device according to the present disclosure includes: biometric information acquisition means for acquiring biometric information included in a captured image captured by a predetermined imaging device; personal authentication means for performing personal authentication using biometric information of a plurality of users stored in advance, for the acquired biometric information; purchase history acquisition means for acquiring, in a case where the personal authentication has succeeded, a purchase history of a user who has succeeded in the personal authentication at a predetermined shop; estimation means for estimating a purchase tendency based on the purchase history; selection means for selecting recommendation information based on the purchase tendency; and output means for outputting the selected recommendation information to a predetermined display terminal.

A recommendation method according to the present disclosure performed by a computer includes: acquiring biometric information included in a captured image captured by a predetermined imaging device; performing personal authentication using biometric information of a plurality of users stored in advance, for the acquired biometric information; acquiring, in a case where the personal authentication has succeeded, a purchase history of a user who has succeeded in the personal authentication at a predetermined shop; estimating a purchase tendency based on the purchase history; selecting recommendation information based on the purchase tendency; and outputting the selected recommendation information to a predetermined display terminal.

A non-transitory computer-readable medium according to the present disclosure records a program for performing: acquiring biometric information included in a captured image captured by a predetermined imaging device; performing personal authentication using biometric information of a plurality of users stored in advance, for the acquired biometric information; acquiring, in a case where the personal authentication has succeeded, a purchase history of a user who has succeeded in the personal authentication at a predetermined shop; estimating a purchase tendency based on the purchase history; selecting recommendation information based on the purchase tendency; and outputting the selected recommendation information to a predetermined display terminal.

### Advantageous Effects of Invention

According to the present disclosure, it is possible to provide the recommendation device, the recommendation system, the recommendation method, and the non-transitory computer-readable medium storing the recommendation program for providing appropriate recommendation information to a user.

### BRIEF DESCRIPTION OF DRAWINGS

FIG. 1 is a block diagram illustrating a configuration of a recommendation device according to a first example embodiment.

FIG. 2 is a flowchart illustrating a flow of a recommendation method according to the first example embodiment.

FIG. 3 is a block diagram illustrating a configuration of a recommendation device according to a second example embodiment.

FIG. 4 is a flowchart illustrating a flow of a recommendation method according to the second example embodiment.

FIG. 5 is a block diagram illustrating a configuration of a recommendation system according to a third example embodiment.

FIG. 6 is a block diagram illustrating a configuration of an authentication device.

FIG. 7 is a flowchart illustrating a flow of biometric information registration processing.

FIG. 8 is a flowchart illustrating a flow of personal authentication processing.

FIG. 9 is a block diagram illustrating a configuration of a service terminal.

FIG. 10 is a block diagram illustrating a configuration of a user terminal.

FIG. 11 is a block diagram illustrating a configuration of a service providing device.

FIG. 12 is a flowchart illustrating a flow of user registration processing.

FIG. 13 is a flowchart illustrating a flow of service user ID generation processing.

FIG. 14 is a sequence chart illustrating a flow of recommendation processing.

FIG. 15 is a block diagram illustrating a configuration of a recommendation system according to a fourth example embodiment.

FIG. 16 is a block diagram illustrating a configuration of a service providing device.

FIG. 17 is a flowchart illustrating a flow of personal information registration processing.

FIG. 18 is a sequence chart illustrating a flow of recommendation processing.

### EXAMPLE EMBODIMENT

Hereinafter, example embodiments of the present disclosure will be described in detail with reference to the drawings. In the drawings, the same or corresponding elements are denoted by the same reference signs, and an overlapping description is omitted as necessary for clarity of description.

### First Example Embodiment

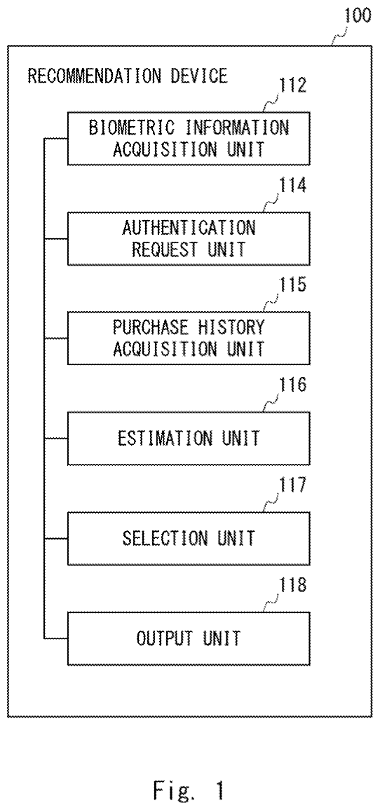

FIG. 1 is a block diagram illustrating a configuration of a recommendation device 100 according to a first example embodiment. The recommendation device 100 includes a biometric information acquisition unit 112, an authentication request unit 114, a purchase history acquisition unit 115, an estimation unit 116, a selection unit 117, and an output unit 118. The recommendation device 100 is connected to a network 500 (not illustrated). The network 500 may be a wired network or a wireless network. An authentication device 200, a service terminal 300, a user terminal 400, and the like (not illustrated) are connected to the network 500.

The biometric information acquisition unit 112 acquires biometric information included in a captured image captured by a predetermined imaging device. The imaging device is, for example, the service terminal 300, the user terminal 400, a camera, or the like. The service terminal 300 is, for example, a communication terminal such as a tablet terminal. The user terminal 400 is a communication terminal such as a smartphone carried by a user. The authentication request unit 114 causes the authentication device 200 that stores biometric information of a plurality of users to perform personal authentication for the acquired biometric information. In a case where the personal authentication has succeeded, the purchase history acquisition unit 115 acquires a purchase history of a user who has succeeded in the personal authentication at a predetermined shop. The estimation unit 116 estimates a purchase tendency based on the purchase history. The selection unit 117 selects recommendation information based on the purchase tendency. The output unit 118 outputs the selected recommendation information to a predetermined display terminal. The display terminal is, for example, the service terminal 300 or the user terminal 400.

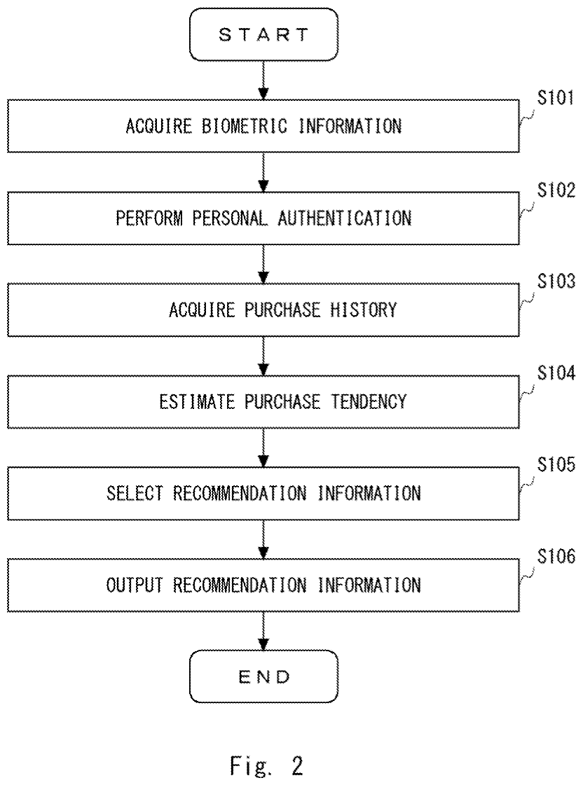

FIG. 2 is a flowchart illustrating a flow of a recommendation method according to the first example embodiment. First, the biometric information acquisition unit 112 acquires biometric information included in a captured image captured by a predetermined imaging device (step S101). Next, the authentication request unit 114 causes the authentication device 200 that stores biometric information of a plurality of users to perform personal authentication for the acquired biometric information (step S102). The authentication device 200 stores user IDs of a plurality of users and biometric information of each user in association with each other in advance. Once a personal authentication request is received from the recommendation device 100, the authentication device 200 collates the biometric information included in the captured image with the biometric information stored in the authentication device 200, and performs the personal authentication by determining whether or not the personal authentication has succeeded based on whether or not the pieces of biometric information match each other. In a case where the personal authentication has succeeded, the authentication device 200 includes, in the determination result, a user ID for which the personal authentication has succeeded, and transmits the determination result as a response to the recommendation device 100.

In a case where the personal authentication has succeeded, the purchase history acquisition unit 115 acquires a purchase history of the user who has succeeded in the personal authentication at a predetermined shop (step S103). Next, the estimation unit 116 estimates a purchase tendency of the user based on the acquired purchase history (step S104). Next, the selection unit 117 selects recommendation information based on the purchase tendency (step S105). Next, the output unit 118 outputs the selected recommendation information to a predetermined display terminal (step S106). As described above, since the recommendation method according to the present example embodiment can present recommendation information based on a purchase tendency of a user, it is possible to provide appropriate recommendation information to a user.

Note that the recommendation device 100 includes a processor, a memory, and a storage device as components not illustrated. Furthermore, the storage device stores a computer program in which processing of the recommendation method according to the present example embodiment is implemented. Then, the processor reads the computer program from the storage device into the memory, and executes the computer program. As a result, the processor implements the functions of the biometric information acquisition unit 112, the authentication request unit 114, the purchase history acquisition unit 115, the estimation unit 116, the selection unit 117, and the output unit 118.

Alternatively, each of the biometric information acquisition unit 112, the authentication request unit 114, the purchase history acquisition unit 115, the estimation unit 116, the selection unit 117, and the output unit 118 may be implemented by dedicated hardware. In addition, some or all of the components of each device may be implemented by a general-purpose or dedicated circuitry, a processor, or the like, or a combination thereof. These may be implemented by a single chip or may be implemented by a plurality of chips connected via a bus. Some or all of the components of each device may be implemented by a combination of the above-described circuit or the like and a program. Furthermore, a central processing unit (CPU), a graphics processing unit (GPU), a field-programmable gate array (FPGA), or the like can be used as the processor.

Furthermore, in a case where some or all of the components of the recommendation device 100 are implemented by a plurality of information processing devices, circuits, and the like, the plurality of information processing devices, circuits, and the like may be arranged in a centralized manner or in a distributed manner. For example, the information processing devices, the circuits, and the like may be implemented in a form in which each of them is connected via a communication network, such as a client server system or a cloud computing system. Furthermore, the function of the recommendation device 100 may be provided in a software as a service (SaaS) format.

### Second Example Embodiment

A second example embodiment is a modification of the first example embodiment described above. The recommendation device 100 according to the first example embodiment performs personal authentication by using the external authentication device 200. On the other hand, a recommendation device 600 according to the present example embodiment performs personal authentication inside the recommendation device 600.

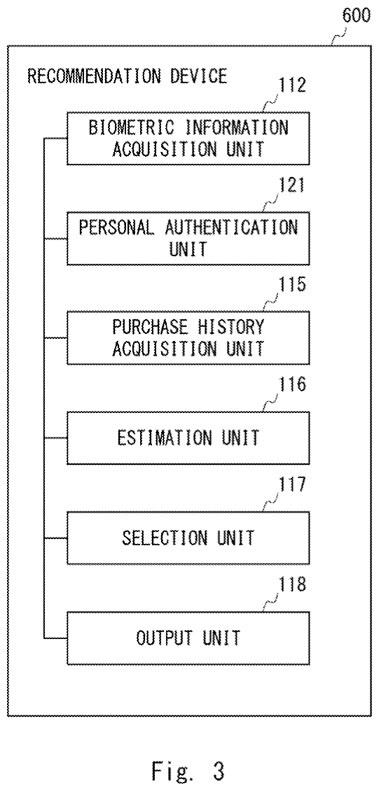

FIG. 3 is a block diagram illustrating a configuration of the recommendation device 600 according to the second example embodiment. In the recommendation device 600, the authentication request unit 114 in the configuration of the recommendation device 100 illustrated in FIG. 1 is replaced with a personal authentication unit 121, and an authentication database (DB) (not illustrated) is further included. The authentication DB is information in which biometric information of a user is associated with a user ID of the user. For each component included in the recommendation device 600, a description overlapping with that of the first example embodiment will be omitted as appropriate.

The personal authentication unit 121 performs personal authentication by using biometric information of a plurality of users stored in advance for the acquired biometric information. In personal authentication, the personal authentication unit 121 collates biometric information included in a captured image with biometric information stored in the authentication DB, and determines whether or not the personal authentication has succeeded based on whether or not the pieces of biometric information match each other. The authentication DB stores biometric information of a plurality of registered users. The personal authentication unit 121 transmits success or failure of the personal authentication to the purchase history acquisition unit 115.

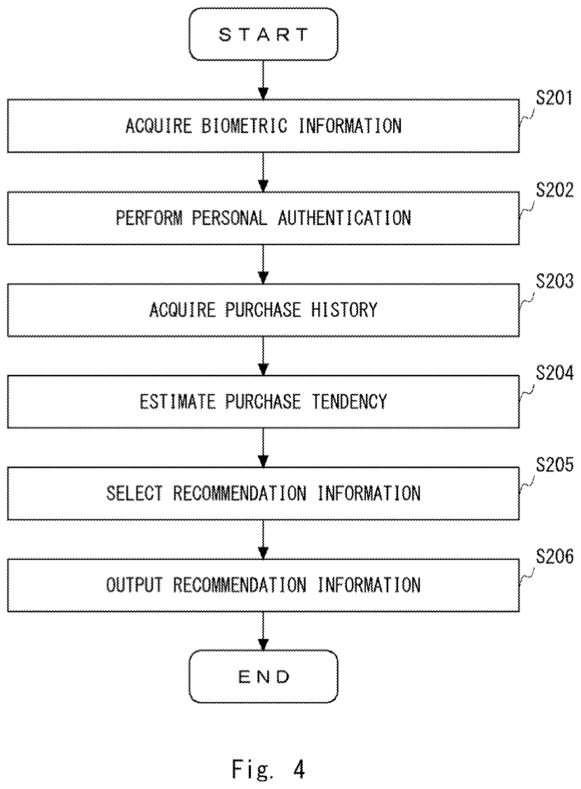

FIG. 4 is a flowchart illustrating a flow of a recommendation method according to the second example embodiment. First, the biometric information acquisition unit 112 acquires biometric information included in a captured image captured by a predetermined imaging device (step S201). Next, the personal authentication unit 121 performs personal authentication by using biometric information of a plurality of users stored in advance for the acquired biometric information (step S202). The authentication DB stores user IDs of a plurality of users and biometric information of each user in association with each other in advance.

In a case where the personal authentication has succeeded, the purchase history acquisition unit 115 acquires a purchase history of the user who has succeeded in the personal authentication at a predetermined shop (step S203). Next, the estimation unit 116 estimates a purchase tendency of the user based on the acquired purchase history (step S204). Next, the selection unit 117 selects recommendation information based on the purchase tendency (step S205). Next, the output unit 118 outputs the selected recommendation information to a predetermined display terminal (step S206). The recommendation device according to the present example embodiment can achieve effects similar to the effects described in the first example embodiment.

### Third Example Embodiment

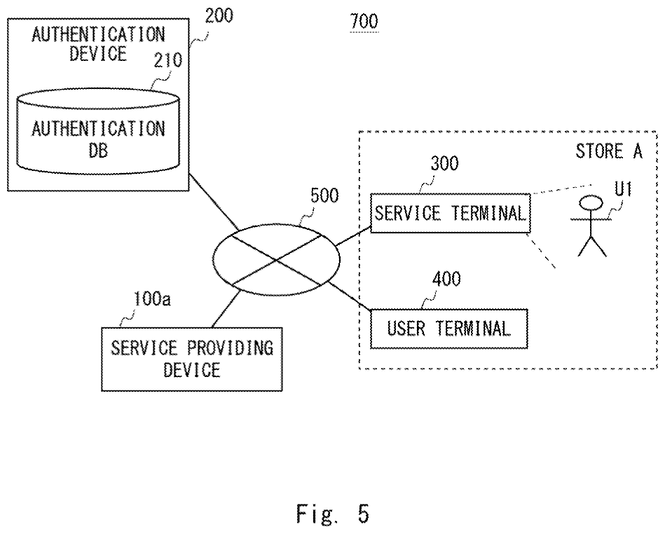

A third example embodiment is a specific example of the first example embodiment described above. FIG. 5 is a block diagram illustrating a configuration of a recommendation system 700 according to the third example embodiment. The recommendation system 700 includes a service providing device 100a, an authentication device 200, a service terminal 300, and a user terminal 400. Each of the service providing device 100a, the authentication device 200, the service terminal 300, and the user terminal 400 is connected via a network 500. Note that a description overlapping with the first example embodiment will be omitted as appropriate.

The service providing device 100a is an example of the recommendation device. The service providing device 100a is an information processing device that performs personal authentication for biometric information included in a captured image, selects recommendation information based on a purchase tendency of a user who has succeeded in the personal authentication in a case where the personal authentication has succeeded, and outputs the selected recommendation information. The service providing device 100a is, for example, a server device implemented by a computer. The authentication device 200 is a device that performs biometric authentication. The biometric authentication is personal authentication based on biometric information. The authentication device 200 includes an authentication DB 210. The authentication DB 210 is a database that stores biometric information and the like for each user.

The service terminal 300 is an information processing device that captures an image including biometric information of a user who intends to purchase a product at a store A, transmits a personal authentication request including the biometric information to the service providing device 100a, and receives and displays recommendation information in a case where the personal authentication has succeeded. The service terminal 300 is installed in the store A. The user terminal 400 is an information processing device operated by a predetermined user. The user terminal 400 is, for example, a communication terminal such as a smartphone, a tablet terminal, or a PC. The user terminal 400 may perform processing similar to that of the service terminal 300 or a part thereof. Hereinafter, it is assumed that a user U1 visits the store A as illustrated in FIG. 5.

The service providing device 100a and the service terminal 300 are devices constituting a system for a service provider to provide a service such as selling a product to a user. Therefore, the authentication device 200 can be said to be a server that operates as an authentication station of a service provider. According to the present example embodiment, the authentication device 200 operates as an authentication station of a plurality of service providers.

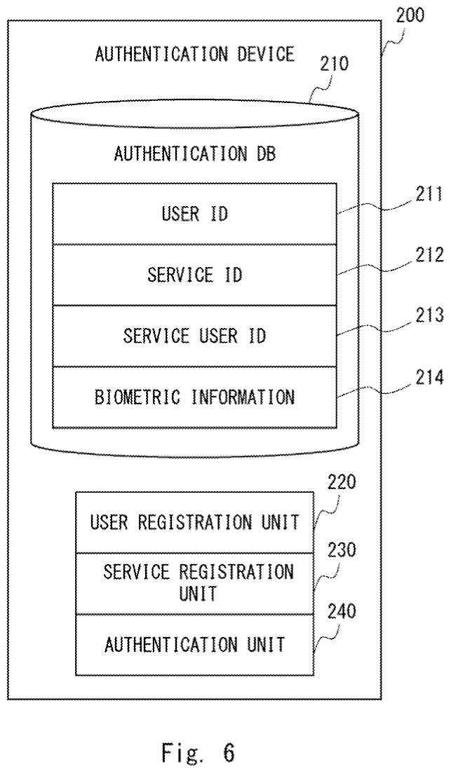

A configuration of the authentication device 200 will be described in detail with reference to FIG. 6. FIG. 6 is a block diagram illustrating the configuration of the authentication device 200. The authentication device 200 includes the authentication DB 210, a user registration unit 220, a service registration unit 230, and an authentication unit 240.

The authentication DB 210 is information in which a service user ID 213 of a corresponding user and biometric information 214 of the user are associated with a user ID 211. The authentication DB 210 further stores a service ID 212. Therefore, the authentication DB 210 can be said to be a database that stores the user ID 211, the service ID 212, the service user ID 213, and the biometric information 214 in association with each other. Here, the service ID 212 is an ID for identifying a service provider. The service user ID 213 is an ID for identifying a user who uses the service. The biometric information 214 is information for identifying a user. The biometric information 214 is, for example, face feature information, a fingerprint, or the like. The face feature information is a set of feature points extracted from a captured image of a face region.

The user registration unit 220 registers the biometric information 214 included in the captured image in the authentication DB 210. The user registration unit 220 newly issues the user ID 211 when registering the biometric information 214. The user registration unit 220 registers the issued user ID 211 and the biometric information 214 included in the captured image in the authentication DB 210 in association with each other.

The service providing device 100a transmits a user registration request including a user ID and a service ID to the authentication device 200. The service registration unit 230 registers the service ID 212 included in the received user registration request in the authentication DB 210. Once the user registration request is received from the service providing device 100a, the service registration unit 230 newly issues the service user ID 213. The service registration unit 230 registers the issued service user ID 213 in the authentication DB 210 in association with the user ID 211 included in the user registration request.

The authentication unit 240 collates biometric information extracted from a captured image with biometric information in the authentication DB 210. The authentication unit 240 determines that the personal authentication has succeeded in a case where the pieces of biometric information match each other, and determines that the personal authentication has failed in a case where the pieces of biometric information do not match each other. The authentication unit 240 transmits success or failure of the personal authentication as a response to the service providing device 100a. Whether or not the pieces of biometric information match each other corresponds to the success or failure of the personal authentication. In addition, in a case where the personal authentication has succeeded, the authentication unit 240 specifies a user ID associated with the biometric information for which the personal authentication has succeeded, and transmits an authentication result including the specified user ID and indicating that the personal authentication has succeeded to the service providing device 100a.

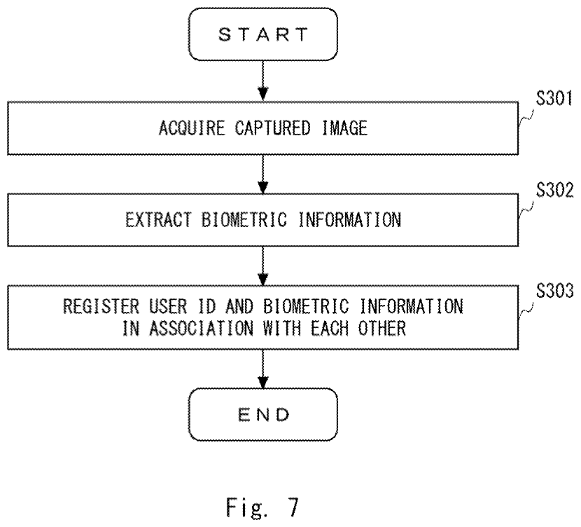

An operation of the authentication device 200 when registering a user ID and biometric information in the authentication DB 210 will be described with reference to FIG. 7. FIG. 7 is a flowchart illustrating a flow of biometric information registration processing.

When registering biometric information, an information registration terminal (not illustrated) captures an image including biometric information of a user, and transmits a biometric information registration request to the authentication device 200 via the network 500. The captured image including the biometric information is, for example, an image including a face region or a fingerprint image. The information registration terminal is, for example, an information processing device such as a personal computer, a smartphone, or a tablet terminal. The information registration terminal is, for example, the user terminal 400. The biometric information registration request includes the captured image. First, the authentication device 200 acquires the captured image included in the biometric information registration request from the information registration terminal via the network 500 (step S301).

Next, the user registration unit 220 extracts the biometric information included in the captured image (step S302), issues a user ID corresponding to the extracted biometric information, and registers the user ID and the biometric information in the authentication DB 210 in association with each other (step S303).

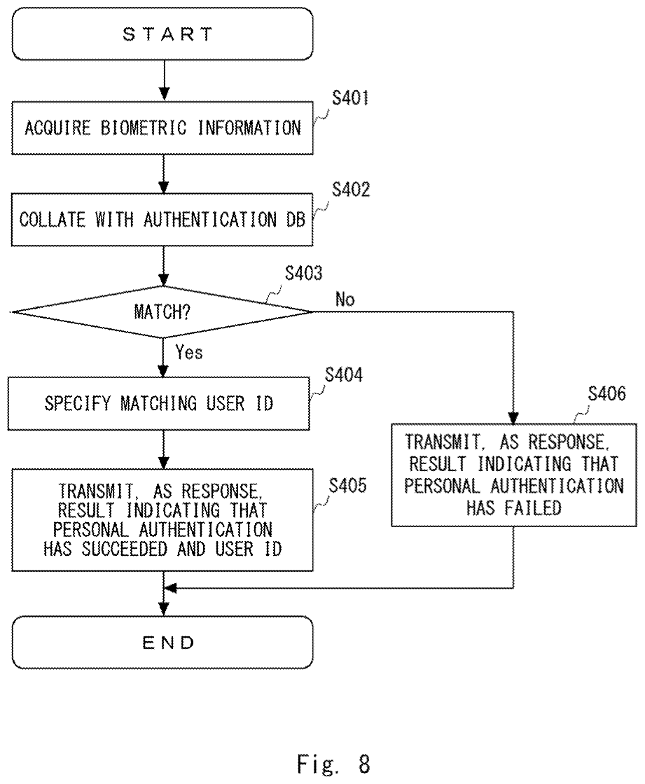

An operation of the authentication device 200 when performing personal authentication will be described with reference to FIG. 8. FIG. 8 is a flowchart illustrating a flow of personal authentication processing. When performing personal authentication, the service terminal 300 captures an image including biometric information of a user, and makes a personal authentication request to the service providing device 100a via the network 500. The personal authentication request includes the captured image. First, the service providing device 100a transmits the captured image or the biometric information extracted from the captured image to the authentication device 200. The authentication unit 240 acquires the biometric information by extracting the biometric information from the received captured image or receiving the biometric information (step S401).

Next, the authentication unit 240 collates the acquired biometric information with biometric information in the authentication DB 210 (step S402). In a case where the pieces of biometric information match each other (Yes in step S403), the authentication unit 240 specifies a user ID of the user whose biometric information matches (step S404), and transmits, as a response, a result indicating that the personal authentication has succeeded and the specified user ID to the service providing device 100a (step S405). In a case where there is no matching biometric information (No in step S403), the authentication unit 240 transmits, as a response, a result indicating that the personal authentication has failed to the service providing device 100a (step S406).

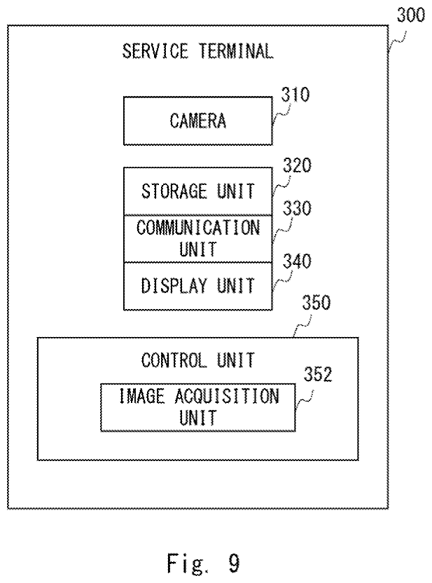

Next, a configuration of the service terminal 300 will be described in detail with reference to FIG. 9. The service terminal 300 includes an imaging device such as a camera, a display terminal, and a computer as hardware components. The service terminal 300 is a device that makes a request for personal authentication by biometric authentication. Examples of the service terminal 300 include, but are not limited to, a terminal that performs payment by biometric authentication, a digital signage that presents information according to biometric authentication, and the like.

FIG. 9 is a block diagram illustrating a configuration of the service terminal 300. The service terminal 300 includes a camera 310, a storage unit 320, a communication unit 330, a display unit 340, and a control unit 350. The camera 310 is an imaging device that captures an image. The storage unit 320 is a storage device that stores a program for implementing each function of the service terminal 300. The communication unit 330 is a communication interface with the network 500. The display unit 340 is a display terminal that displays a personal authentication result, recommendation information, and the like to a user. The control unit 350 controls hardware included in the service terminal 300. The control unit 350 includes an image acquisition unit 352.

The image acquisition unit 352 transmits an imaging request to the camera 310. The camera 310 captures an image including a user's face region, a fingerprint, or the like. The image captured by the camera 310 is used at the time of personal authentication or the like. The image acquisition unit 352 transmits a personal authentication request including the captured image to the service providing device 100a.

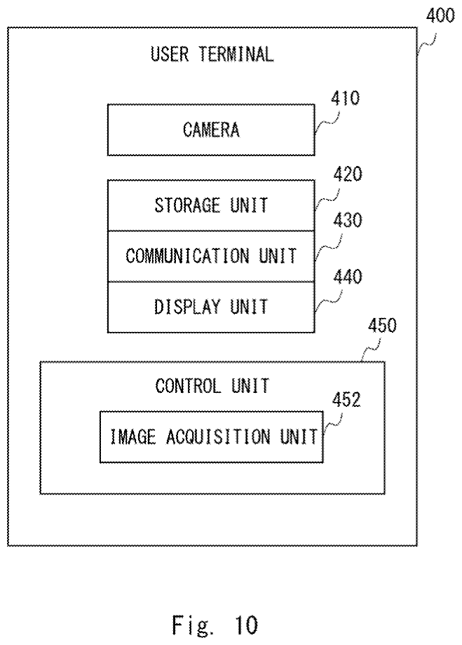

Next, a configuration of the user terminal 400 will be described in detail with reference to FIG. 10. The user terminal 400 includes an imaging device such as a camera, a display terminal, and a computer as hardware components. The user terminal 400 is a device that makes a request for personal authentication by biometric authentication. FIG. 10 is a block diagram illustrating a configuration of the user terminal 400. The user terminal 400 includes a camera 410, a storage unit 420, a communication unit 430, a display unit 440, and a control unit 450. The control unit 450 includes an image acquisition unit 452. Since the function of each component included in the user terminal 400 is similar to that of each component included in the service terminal 300, a description thereof will be omitted.

The service terminal 300 and the user terminal 400 may operate as the information registration terminal. In this case, the service terminal 300 and the user terminal 400 further include a biometric information registration unit (not illustrated), and have a function of making a biometric information registration request. Hereinafter, a flow of the biometric information registration processing will be described. Note that, although a case where the service terminal 300 performs the biometric information registration processing will be described, similar processing may be performed by the user terminal 400.

When making a biometric information registration request, first, the image acquisition unit 352 controls the camera 310 to capture an image including biometric information of a user. Next, the biometric information registration unit transmits a biometric information registration request including the captured image to the authentication device 200 via the network 500. Finally, the biometric information registration unit receives the registration result from the authentication device 200. Note that the biometric information registration unit may transmit a biometric information registration request including the biometric information extracted from the captured image to the authentication device 200.

The service terminal 300 and the user terminal 400 may operate as a payment terminal (not illustrated). The payment terminal is a terminal that makes a payment for a product in response to a request from a user and transmits corresponding payment information to the service providing device 100a as a purchase history of the user. In this case, the service terminal 300 and the user terminal 400 further include a payment unit and a purchase history registration request unit (not illustrated), and have a function of making a purchase history registration request. The payment terminal may perform a payment by biometric authentication or may perform a payment by other methods. Hereinafter, a flow of purchase history registration request processing when making a payment by biometric authentication will be described. Note that, although a case where the service terminal 300 operates as the payment terminal and performs the purchase history registration request processing will be described, similar processing may be performed by the service terminal 300.

When making a payment by biometric authentication, the image acquisition unit 352 included in the service terminal 300 acquires an image including biometric information of a user and transmits a personal authentication request to the service providing device 100a. In a case where the personal authentication has succeeded, the payment unit 355 performs payment processing. Next, the purchase history registration request unit transmits a purchase history registration request including a service user ID and a purchase history of the user to the service providing device 100a.

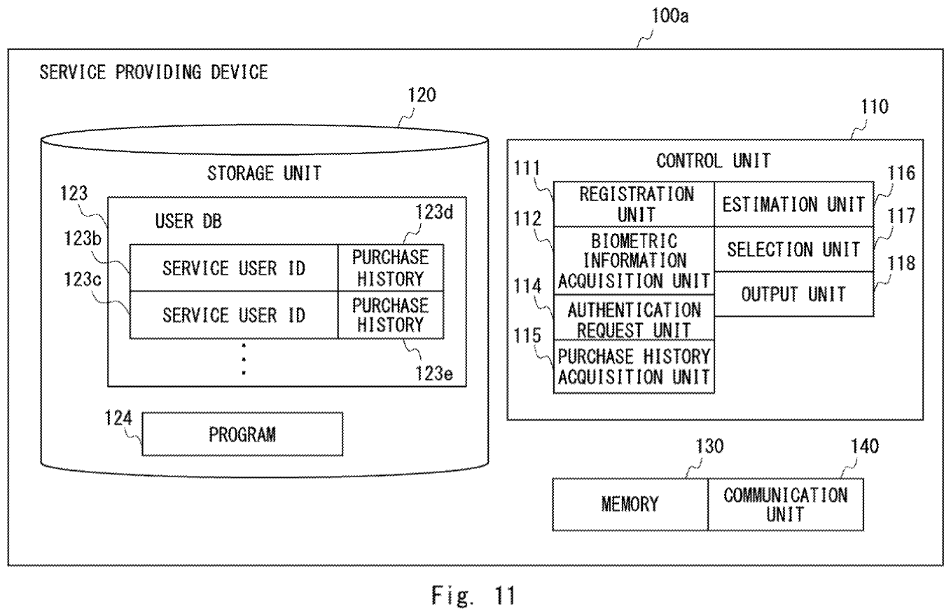

Next, a configuration of the service providing device 100a will be described in detail with reference to FIG. 11. FIG. 11 is a block diagram illustrating a configuration of the service providing device 100a. The service providing device 100a includes a control unit 110, a storage unit 120, a memory 130, and a communication unit 140.

The storage unit 120 is a storage device that stores a user DB 123 and a program 124. The user DB 123 is information in which a purchase history of a user is associated with a service user ID. Service user IDs 123b and 123c are identification information that enables identification of a user who uses a service provided by a service provider, and are, for example, a name, a telephone number, an e-mail address, an arbitrary identification number, or the like. Purchase histories 123d and 123e are associated with the service user IDs 123b and 123c, respectively. The purchase histories 123d and 123e are product purchase histories of users at a predetermined shop. The purchase history includes at least the type of the product purchased by the user, and may further include a date when the user has purchased the product, a price of the product, and the like. The predetermined shop may be, for example, a real shop such as a supermarket or a convenience store, or may be an online shop that sells products on the Internet. The program 124 is a computer program in which the recommendation processing according to the present example embodiment is implemented.

The memory 130 is a storage region for temporarily storing processing contents of the control unit 110, and is, for example, a volatile storage device such as a random access memory (RAM). The communication unit 140 is an interface that communicates with the outside of the service providing device 100a.

The control unit 110 includes a registration unit 111, a biometric information acquisition unit 112, an authentication request unit 114, a purchase history acquisition unit 115, an estimation unit 116, a selection unit 117, and an output unit 118. The control unit 110 is a control device that controls the operation of the service providing device 100a, and is, for example, a processor such as a CPU. The control unit 110 reads the program 124 from the storage unit 120 into the memory 130 and executes the program 124. As a result, the control unit 110 implements the functions as the registration unit 111, the biometric information acquisition unit 112, the authentication request unit 114, the purchase history acquisition unit 115, the estimation unit 116, the selection unit 117, and the output unit 118.

The registration unit 111 receives a purchase history registration request from the payment terminal via the network 500. The purchase history registration request includes a service user ID and a purchase history of a corresponding user. The registration unit 111 registers the received purchase history in the user DB 123 in association with the service user ID included in the received purchase history registration request. Note that the purchase history registration processing is not limited thereto. The payment terminal is, for example, the service terminal 300 or the user terminal 400.

The biometric information acquisition unit 112 receives a captured image from an imaging device such as the service terminal 300 and extracts biometric information from the captured image. The biometric information acquisition unit 112 may also receive biometric information extracted from the captured image. The imaging device such as the service terminal 300 is installed, for example, in the predetermined store A. When the user U1 visits the store A, the imaging device captures an image including biometric information of the user U1, and transmits the image or the extracted biometric information to the biometric information acquisition unit 112. In this manner, the biometric information acquisition unit 112 acquires biometric information of a user when the user visits a predetermined shop.

When biometric information is acquired, the authentication request unit 114 causes the authentication device 200 to perform personal authentication on the acquired biometric information. In a case where the personal authentication has succeeded, the purchase history acquisition unit 115 acquires a purchase history corresponding to a service user ID of the corresponding user from the user DB.

The estimation unit 116 estimates a purchase tendency of a user based on the acquired purchase history. The purchase tendency is information indicating a pattern of an interval or a period at and in which the user purchases a specific product. For example, in a case where the user has purchased the specific product a plurality of times, the purchase tendency includes a time to make the next purchase of the product. Alternatively, the purchase tendency may be information indicating a combination of a plurality of types of products to be collectively purchased by the user. The estimation unit 116 extracts a purchase history of the specific product included in the acquired purchase history, and estimates a time to make the next purchase of the product. The estimation unit 116 may estimate a purchase tendency for one type of product included in the purchase history, or may estimate a purchase tendency for a plurality of products included in the purchase history.

The selection unit 117 selects recommendation information to be presented to a user based on an estimated purchase tendency. The recommendation information is, for example, a discount coupon that can be used by the user U1 when a product for which a purchase tendency has been estimated is purchased at the store A. Alternatively, the recommendation information may be the product itself for which the purchase tendency has been estimated. The output unit 118 outputs the selected recommendation information to a predetermined display terminal such as the service terminal 300 or the user terminal 400.

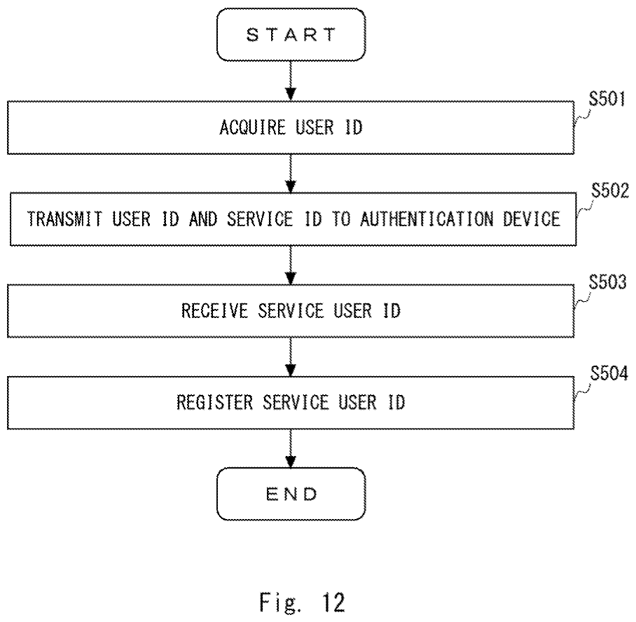

Next, an operation of the service providing device 100a at the time of user registration will be described with reference to FIG. 12. FIG. 12 is a flowchart illustrating a flow of user registration processing. An operation of the service providing device 100a when the user U1 is registered in the storage unit 120 will be described.

The user U1 performs user registration for each service provider. At the time of user registration, the user U1 inputs a user ID to an information registration terminal such as the service terminal 300 or the user terminal 400. Once the input is received, the information registration terminal makes a user registration request to the service providing device 100a via the network 500. The user registration request includes a user ID. The registration unit 111 acquires the user ID of the user U1 by receiving the user registration request (step S501). Next, the communication unit 140 transmits the user ID and the service ID of the service providing device 100a to the authentication device 200 via the network 500 (step S502). The authentication device 200 transmits a service user ID in response to the reception of the user ID and the service ID. The registration unit 111 receives the service user ID (step S503), and registers the service user ID in the user DB 123 (step S504).

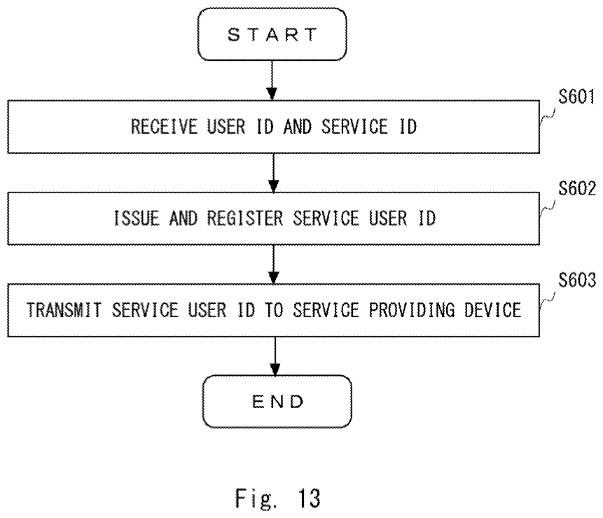

An operation of the authentication device 200 when the user ID and the service ID are received in step S502 will be described with reference to FIG. 13. FIG. 13 is a flowchart illustrating a flow of service user ID generation processing. When the user ID and the service ID are received (step S601), the authentication device 200 newly issues a service user ID 213, and registers the service user ID 213 in the authentication DB 210 in association with the received user ID 211 (step S602). The service registration unit 230 transmits, as a response, the issued service user ID 213 to the service providing device 100a (step S603).

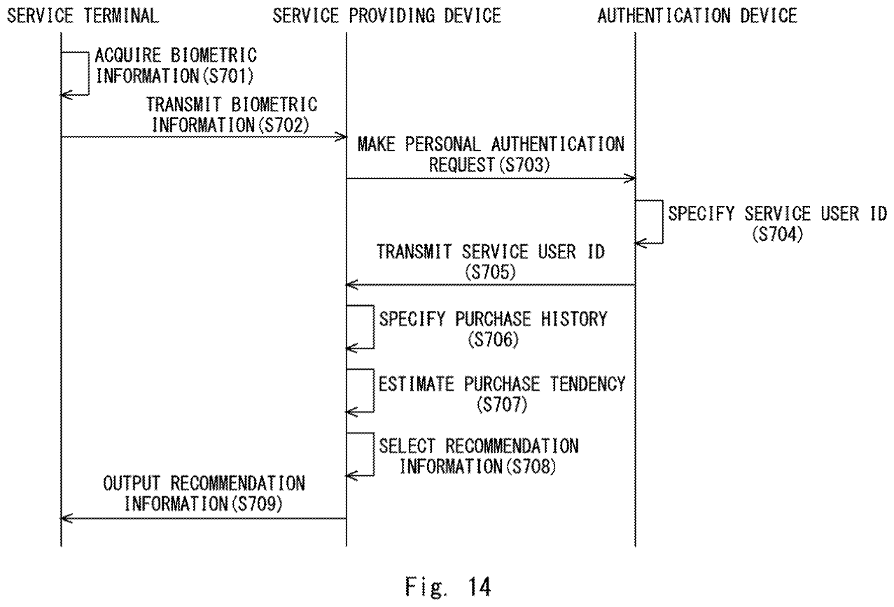

Next, an operation of the recommendation system 700 at the time of recommendation processing will be described with reference to FIG. 14. FIG. 14 is a sequence chart illustrating a flow of the recommendation processing. Note that, at the time of performing the recommendation processing, it is assumed that a user has performed user registration for the service providing device 100a in advance. First, the service terminal 300 acquires biometric information by extracting the biometric information from a captured image including the biometric information of the user (step S701). Next, the service terminal 300 transmits the acquired biometric information to the service providing device 100a (step S702). Next, the service providing device 100a transmits a personal authentication request including the received biometric information to the authentication device 200 (step S703).

The authentication device 200 performs personal authentication for the received biometric information and specifies a service user ID of the user who has succeeded in the personal authentication (step S704). Next, the authentication device 200 transmits, as a response, a result indicating that the personal authentication has succeeded and the specified service user ID to the service providing device 100a (step S705). The service providing device 100a specifies a purchase history associated with the received service user ID (step S706).

Next, the service providing device 100a estimates a purchase tendency of the user based on the acquired purchase history (step S707). Next, the service providing device 100a selects recommendation information based on the purchase tendency of the user (step S708). Next, the service providing device 100a outputs the recommendation information to the service terminal 300 (step S709). The service terminal 300 presents the received recommendation information to the user. A timing at which the recommendation information is presented to the user is, for example, a timing at which the user U1 visits the store A.

The service terminal 300 is, for example, a digital signage installed at an entrance of a store or the like. In this case, the selection unit 117 selects recommendation information (for example, a discount coupon for a specific product or the like) based on a service user ID of a user who stands in front of the digital signage and whose face has been detected. The output unit 118 presents the recommendation information to the user by displaying, for example, a recommendation information form and a two-dimensional code such as a QR code (registered trademark) for reading the recommendation information on the digital signage. The user can acquire the recommendation information by reading the two-dimensional code with a smartphone or the like. Further, a print button may be further displayed on the digital signage, and the user may acquire the recommendation information by pressing the print button to print the recommendation information form.

The digital signage may be linked with face authentication payment. In this case, an acquisition button may be displayed on the digital signage, and when the acquisition button is pressed, the recommendation information (for example, a coupon) may be automatically applied at the time of face authentication payment. In addition, the recommendation information displayed on the digital signage may be displayed again at the time of face authentication payment, and payment to which the recommendation information is applied may be made when the user makes a selection.

The output unit 118 may display the recommendation information on the digital signage and transmit the recommendation information to an information terminal such as a smartphone of the user who has succeeded in the personal authentication. In this case, the recommendation information may be transmitted to an application in the smartphone, or may be transmitted by e-mail or the like.

Hereinafter, a specific example of recommendation information presented to a user by a service provider in the present example embodiment will be described. Specific examples of the recommendation information presented to a user by a service provider may include “a coupon available at the next purchase time of a regularly purchased product”. In this case, the estimation unit 116 extracts a purchase history of a specific product (for example, daily necessities such as toilet paper) purchased a plurality of times from a purchase history of the user, and estimates a time to make the next purchase of the product. When the user visits the store at the next purchase time of the product, the output unit 118 outputs a discount coupon for the product.

Other specific examples of the recommendation information presented to a user by a service provider may include “a coupon available in a case where a cumulative purchase amount of the user in the store is equal to or more than a predetermined amount”. In this case, the purchase history stored in the user DB 123 includes a purchase amount of the user at the store. The estimation unit 116 calculates the cumulative purchase amount of the user at the store from the purchase history of the user. The selection unit 117 selects the type of coupon, the discount amount, and the like according to the calculated cumulative purchase amount.

### Fourth Example Embodiment

A fourth example embodiment is a modification of the third example embodiment described above. In the recommendation system 700 according to the third example embodiment, recommendation information is selected based on a purchase tendency of a user. On the other hand, in the fourth example embodiment, recommendation information is selected in consideration of personal information of a user.

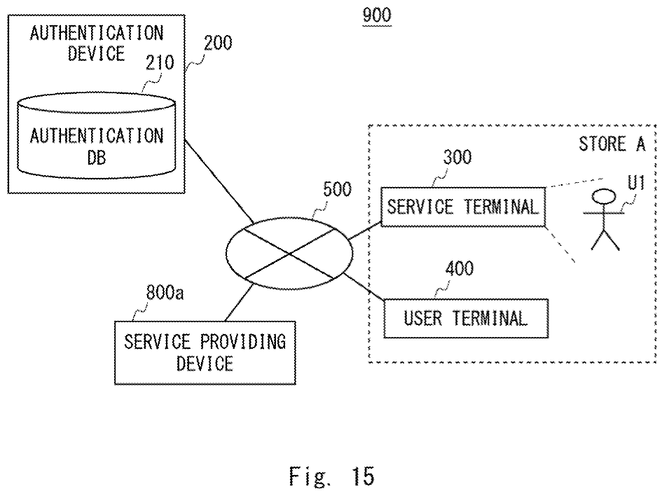

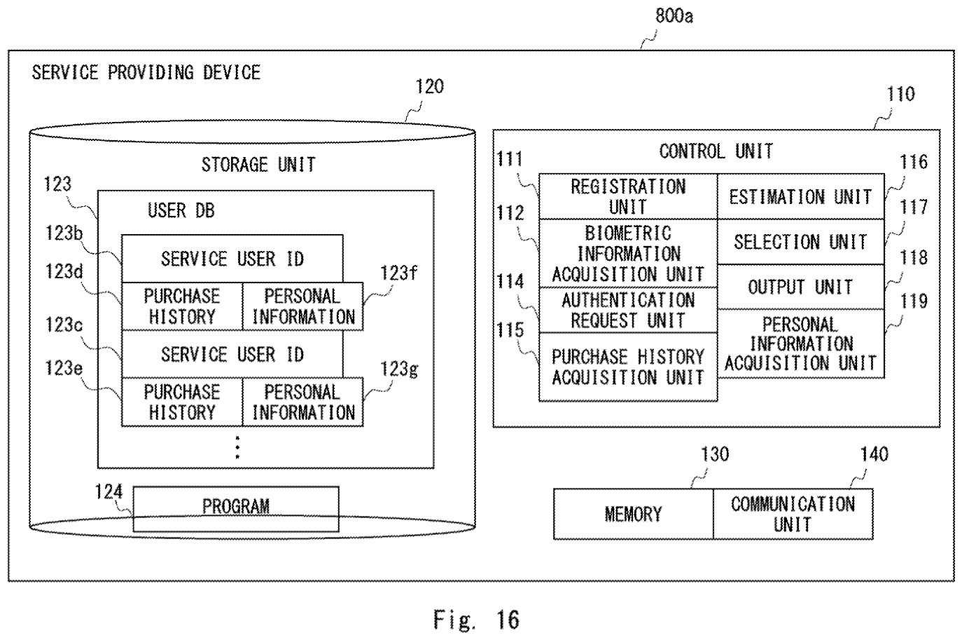

FIG. 15 is a block diagram illustrating a configuration of a recommendation system 900 according to the fourth example embodiment. In the recommendation system 900, the service providing device 100a in the configuration of the recommendation system 700 illustrated in FIG. 5 is replaced with a service providing device 800a. For each component included in the recommendation system 900, a description overlapping with that of the third example embodiment will be omitted as appropriate. FIG. 16 is a block diagram illustrating a configuration of the service providing device 800a according to the fourth example embodiment. The service providing device 800a is different from the service providing device 100a in that personal information is stored in a user DB 123 in association with a service user ID, a control unit 110 includes a personal information acquisition unit 119, and a selection unit 117 selects recommendation information in consideration of the personal information. Since the other components are similar, a description thereof will be omitted as appropriate.

Pieces of personal information 123f and 123g are information regarding users. The personal information is, for example, an anniversary such as a user's birthday, a date on which a user performs user registration for a service provider, or the like. A purchase history 123d and the personal information 123f are associated with a service user ID 123b, and a purchase history 123e and the personal information 123g are associated with a service user ID 123c. The personal information acquisition unit 119 acquires personal information corresponding to a service user ID of a user who has succeeded in personal authentication from the user DB 123. The selection unit 117 selects recommendation information to be presented to a user based on a purchase tendency of the user and personal information of the user.

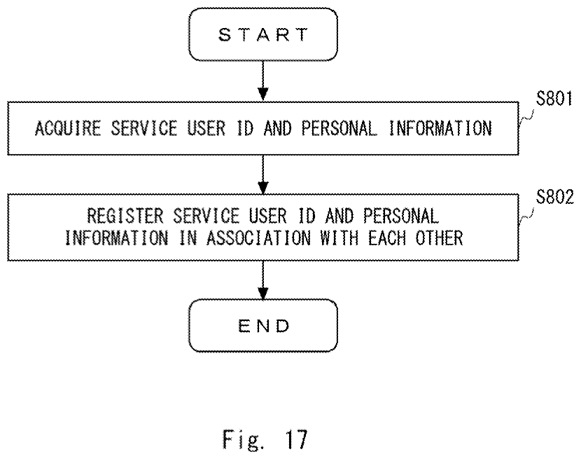

Next, an operation of the service providing device 100a at the time of personal information registration will be described with reference to FIG. 17. FIG. 17 is a flowchart illustrating a flow of personal information registration processing. A user performs personal information registration for a service provider for which the user has performed user registration in advance. At the time of personal information registration, the user inputs a service user ID to an information registration terminal such as a service terminal 300 and a user terminal 400. Once the input is received, the information registration terminal makes a personal information registration request to the service providing device 100a via a network 500. The personal information registration request includes the service user ID and personal information. A registration unit 111 receives the personal information registration request to acquire the service user ID and the personal information of the user (step S801). Next, the registration unit 111 registers the received personal information in the user DB 123 in association with the service user ID included in the received personal information registration request (step S802).

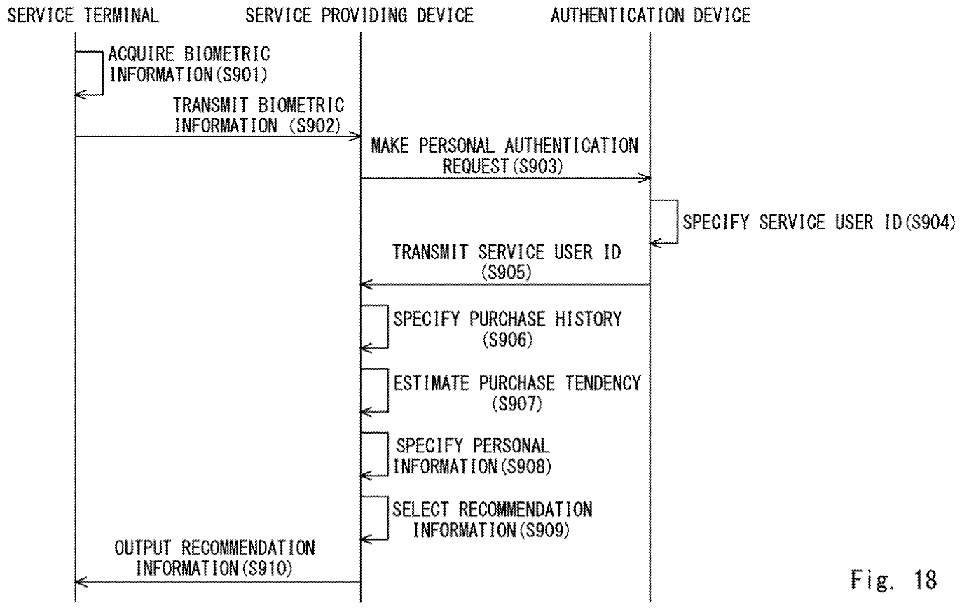

Next, an operation of the recommendation system 900 at the time of recommendation processing will be described with reference to FIG. 18. FIG. 18 is a sequence chart illustrating a flow of the recommendation processing. Note that, at the time of performing the recommendation processing, it is assumed that a user has performed user registration for the service providing device 800a in advance. First, the service terminal 300 acquires biometric information by extracting the biometric information from a captured image including the biometric information of the user (step S901). Next, the service terminal 300 transmits the acquired biometric information to the service providing device 800a (step S902). Next, the service providing device 800a transmits a personal authentication request including the received biometric information to an authentication device 200 (step S903).

The authentication device 200 performs personal authentication for the received biometric information and specifies a service user ID of the user who has succeeded in the personal authentication (step S904). Next, the authentication device 200 transmits, as a response, a result indicating that the personal authentication has succeeded and the specified service user ID to the service providing device 800a (step S905). The service providing device 800a specifies a purchase history associated with the received service user ID (step S906).

Next, the service providing device 100a estimates a purchase tendency of the user based on the acquired purchase history (step S907). Next, the service providing device 100a specifies personal information associated with the received service user ID (step S908). Note that step S908 may be performed in parallel with steps S906 and S907. Next, the service providing device 100a selects recommendation information based on the purchase tendency and personal information of the user (step S909). Next, the service providing device 100a outputs the recommendation information to the service terminal 300 (step S910). The service terminal 300 presents the received recommendation information to the user.

Hereinafter, a specific example of recommendation information presented to a user by a service provider in the present example embodiment will be described. Specific examples of the recommendation information may include “a coupon available for a user's birthday”. In this case, personal information stored in the user DB 123 includes a user's birthday. The selection unit 117 selects a coupon based on a purchase tendency of a user and the user's birthday. Furthermore, the selection unit 117 may select a coupon based on only a user's birthday. In a case where a user visits a store within one week before and after his/her birthday, the output unit 118 outputs a selected coupon.

### Other Embodiments and the Like

Note that, in the above-described example embodiments, a case where when personal authentication has succeeded, a purchase history of a user who has succeeded in the personal authentication is acquired, and a purchase tendency is estimated based on the purchase history has been described. However, a purchase tendency of each user may be estimated in advance, and recommendation information may be selected based on the purchase tendency estimated in advance when personal authentication has succeeded. In this case, the purchase history acquisition unit 115 acquires a purchase history of each user from the user DB 123 before personal authentication is performed. Next, the estimation unit 116 estimates a purchase tendency of each user based on the acquired purchase history. When personal authentication has succeeded, the selection unit 117 selects recommendation information to be presented to a user who has succeeded in the personal authentication based on the estimated purchase tendency.

Furthermore, the user DB 123 may be information in which group information is associated with a service user ID in addition to a purchase history of a user. The group information includes information on a group (for example, a family) to which the user belongs, a purchase history of each person belonging to the group, and the like. In this case, the purchase history acquisition unit 115 acquires a purchase history and group information of a user who has succeeded in personal authentication from the user DB 123. The estimation unit 116 may extract a purchase history of each person belonging to a group from the acquired group information, and estimate a purchase tendency based on the purchase history. For example, when a husband visits a store, the estimation unit 116 estimates a purchase tendency based on a purchase history of a wife associated with the husband (regularly purchasing milk of the same brand). The selection unit 117 selects, as recommendation information, milk regularly purchased by the wife. In a case where the husband has purchased the recommended milk, the selection unit 117 does not have to recommend the milk when the wife visits the store in the near future. Note that, in this case, the service user ID may be a service group ID assigned to each group. The service group ID is identification information that enables identification of a group to which a user who uses a service provided by a service provider belongs, and is used when each person who belongs to the group uses the service.

Only a user having a coupon or a voucher may be allowed to purchase a specific product (for example, a mask), and the selection unit 117 does not have to issue the coupon or the voucher for the product in a case where the user has a tendency to purchase the product in a large amount recently. As a result, it is possible to prevent a specific product from being bought up. In this case, the selection unit 117 issues a coupon or a voucher for purchasing the product at the store to a user who has not purchased the product for a predetermined period. The user can obtain a sense of security that he/she can purchase or exchange the product at the store at a predetermined interval (for example, when a stock of masks runs out).

Note that, although the hardware configuration has been described in the above-described example embodiments, the present disclosure is not limited thereto. According to the present disclosure, arbitrary processing can also be implemented by causing a CPU to execute a computer program.

In the above example, the program may be stored using various types of non-transitory computer-readable media and supplied to a computer. The non-transitory computer-readable media include various types of tangible storage media. Examples of the non-transitory computer-readable medium include a magnetic recording medium (for example, a flexible disk, a magnetic tape, or a hard disk drive), an optical magnetic recording medium (for example, a magneto-optical disk), a compact disc-read only memory (CD-ROM), a CD-R, a CD-R/W, a digital versatile disc (DVD), and a semiconductor memory such as a mask ROM, a programmable ROM (PROM), an erasable PROM (EPROM), a flash ROM, or a random access memory (RAM). In addition, the program may be supplied to the computer by various types of transitory computer-readable media. Examples of the transitory computer-readable medium include an electric signal, an optical signal, and electromagnetic waves. The transitory computer-readable medium can provide the program to the computer via a wired communication line such as electric wires and optical fibers or a wireless communication line.

Note that the present disclosure is not limited to the above example embodiments, and can be appropriately changed without departing from the gist. Furthermore, the present disclosure may be implemented by appropriately combining the respective example embodiments.

Some or all of the above example embodiments may be described as the following supplementary notes, but are not limited to the following.

(Supplementary Note A1)

A recommendation device including:

a biometric information acquisition unit that acquires biometric information included in a captured image captured by a predetermined imaging device;

an authentication request unit that causes an authentication device that stores biometric information of a plurality of users to perform personal authentication for the acquired biometric information;

a purchase history acquisition unit that acquires, in a case where the personal authentication has succeeded, a purchase history of a user who has succeeded in the personal authentication at a predetermined shop;

an estimation unit that estimates a purchase tendency based on the purchase history;

a selection unit that selects recommendation information based on the purchase tendency; and

an output unit that outputs the selected recommendation information to a predetermined display terminal.

(Supplementary Note A2)

The recommendation device according to Supplementary Note A1,

in which the estimation unit extracts a purchase history of at least one type of product included in the purchase history and estimates a purchase tendency for the product.

(Supplementary Note A3)

The recommendation device according to Supplementary Note A1 or A2, in which

the estimation unit estimates, as the purchase tendency, a time at which a next purchase of a specific product is to be made by the user based on the purchase history, and

the output unit outputs the selected recommendation information at the time at which the next purchase is to be made.

(Supplementary Note A4)

The recommendation device according to Supplementary Note A3, in which the output unit outputs the selected recommendation information

in a case where a time at which the user visits the predetermined shop is the time at which the next purchase is to be made.

(Supplementary Note A5)

The recommendation device according to any one of Supplementary Notes A1 to A4,

in which the recommendation information is a coupon that is available when a cumulative purchase amount of the user at the predetermined shop is equal to or more than a predetermined amount.

(Supplementary Note A6)

The recommendation device according to any one of Supplementary Notes A1 to A5, in which

the predetermined imaging device is installed in the predetermined shop, and

the biometric information acquisition unit acquires the biometric information when the user visits the predetermined shop.

(Supplementary Note A7)

The recommendation device according to any one of Supplementary Notes A1 to A6,

in which the output unit outputs the selected recommendation information when the user visits the predetermined shop.

(Supplementary Note A8)

The recommendation device according to any one of Supplementary Notes A1 to A7,

in which the recommendation information is a coupon that is available in the predetermined shop.

(Supplementary Note A9)

The recommendation device according to Supplementary Note A8, in which

the purchase history includes a purchase amount of the user at the predetermined shop, and

a discount amount of the coupon is determined according to the cumulative purchase amount of the user.

(Supplementary Note A10)

The recommendation device according to any one of Supplementary Notes A1 to A9, further including a personal information acquisition unit that acquires personal information of the user,

in which the selection unit selects the recommendation information based on the personal information and the purchase tendency.

(Supplementary Note A11)

The recommendation device according to Supplementary Note A10, in which the personal information includes a birthday of the user.

(Supplementary Note B1)

A recommendation system including:

an imaging device that captures an image including biometric information of a predetermined user;

a recommendation device that is configured to perform communication with the imaging device; and

an authentication device that stores the biometric information of the user and is configured to perform communication with the recommendation device,

in which the recommendation device includes:

a biometric information acquisition unit that acquires biometric information included in a captured image captured by a predetermined imaging device;

an authentication request unit that causes the authentication device to perform personal authentication for the acquired biometric information;

a purchase history acquisition unit that acquires, in a case where the personal authentication has succeeded, a purchase history of a user who has succeeded in the personal authentication at a predetermined shop;

an estimation unit that estimates a purchase tendency based on the purchase history;

a selection unit that selects recommendation information based on the purchase tendency; and

an output unit that outputs the selected recommendation information to a predetermined display terminal.

(Supplementary Note B2)

The recommendation system according to Supplementary Note B1,

in which the estimation unit extracts a purchase history of at least one type of product included in the purchase history and estimates a purchase tendency for the product.

(Supplementary Note C1)

A recommendation method performed by a computer, the recommendation method including:

acquiring biometric information included in a captured image captured by a predetermined imaging device;

causing an authentication device that stores biometric information of a plurality of users to perform personal authentication for the acquired biometric information;

acquiring, in a case where the personal authentication has succeeded, a purchase history of a user who has succeeded in the personal authentication at a predetermined shop;

estimating a purchase tendency based on the purchase history;

selecting recommendation information based on the purchase tendency; and

outputting the selected recommendation information to a predetermined display terminal.

(Supplementary Note D1)

A non-transitory computer-readable medium storing a recommendation program that causes a computer to perform:

acquiring biometric information included in a captured image captured by a predetermined imaging device;

causing an authentication device that stores biometric information of a plurality of users to perform personal authentication for the acquired biometric information;

acquiring, in a case where the personal authentication has succeeded, a purchase history of a user who has succeeded in the personal authentication at a predetermined shop;

estimating a purchase tendency based on the purchase history;

selecting recommendation information based on the purchase tendency; and

outputting the selected recommendation information to a predetermined display terminal.

(Supplementary Note E1)

A recommendation device including:

a biometric information acquisition unit that acquires biometric information included in a captured image captured by a predetermined imaging device;

a personal authentication unit that performs personal authentication for the acquired biometric information by using biometric information of a plurality of users stored in advance;

a purchase history acquisition unit that acquires a purchase history of a user who has succeeded in the personal authentication at a predetermined shop in a case where the personal authentication has succeeded;

an estimation unit that estimates a purchase tendency based on the purchase history;

a selection unit that selects recommendation information based on the purchase tendency; and

an output unit that outputs the selected recommendation information to a predetermined display terminal.

(Supplementary Note E2)

The recommendation device according to Supplementary Note E1,

in which the estimation unit extracts a purchase history of at least one type of product included in the purchase history and estimates a purchase tendency for the product.

(Supplementary Note F1)

A recommendation method performed by a computer, the recommendation method including:

acquiring biometric information included in a captured image captured by a predetermined imaging device;

performing personal authentication using biometric information of a plurality of users stored in advance, for the acquired biometric information;

acquiring, in a case where the personal authentication has succeeded, a purchase history of a user who has succeeded in the personal authentication at a predetermined shop;

estimating a purchase tendency based on the purchase history;

selecting recommendation information based on the purchase tendency; and

outputting the selected recommendation information to a predetermined display terminal.

(Supplementary Note G1)

A non-transitory computer-readable medium storing a recommendation program that causes a computer to perform:

acquiring biometric information included in a captured image captured by a predetermined imaging device;

performing personal authentication using biometric information of a plurality of users stored in advance, for the acquired biometric information;

acquiring, in a case where the personal authentication has succeeded, a purchase history of a user who has succeeded in the personal authentication at a predetermined shop;

estimating a purchase tendency based on the purchase history;

selecting recommendation information based on the purchase tendency; and

outputting the selected recommendation information to a predetermined display terminal.

Although the present invention has been described with reference to the example embodiments (and examples), the present invention is not limited to the above example embodiments (and examples). Various modifications that can be understood by those skilled in the art can be made to the configuration and details of the present invention within the scope of the present invention.

### REFERENCE SIGNS LIST

100, 600 RECOMMENDATION DEVICE
100a, 800a SERVICE PROVIDING DEVICE
110 CONTROL UNIT
111 REGISTRATION UNIT
112 BIOMETRIC INFORMATION ACQUISITION UNIT
114 AUTHENTICATION REQUEST UNIT
115 PURCHASE HISTORY ACQUISITION UNIT
116 ESTIMATION UNIT
117 SELECTION UNIT
118 OUTPUT UNIT
119 PERSONAL INFORMATION ACQUISITION UNIT
120 STORAGE UNIT
121 PERSONAL AUTHENTICATION UNIT
123 USER DB
123b, 123c SERVICE USER ID
123d, 123e PURCHASE HISTORY
123f, 123g PERSONAL INFORMATION
124 PROGRAM
130 MEMORY
140 COMMUNICATION UNIT
200 AUTHENTICATION DEVICE
210 AUTHENTICATION DB
211 USER ID
212 SERVICE ID
213 SERVICE USER ID
214 BIOMETRIC INFORMATION
220 USER REGISTRATION UNIT
230 SERVICE REGISTRATION UNIT
240 AUTHENTICATION UNIT
300 SERVICE TERMINAL
310 CAMERA
320 STORAGE UNIT
330 COMMUNICATION UNIT
340 DISPLAY UNIT
350 CONTROL UNIT
352 IMAGE ACQUISITION UNIT
355 PAYMENT UNIT
400 USER TERMINAL
410 CAMERA
420 STORAGE UNIT
430 COMMUNICATION UNIT
440 DISPLAY UNIT
450 CONTROL UNIT
452 IMAGE ACQUISITION UNIT
500 NETWORK
700, 900 RECOMMENDATION SYSTEM

What is claimed is:

1. A recommendation device comprising:
at least one memory acquiring storing instructions and
at least one processor configured to execute the instructions to;
acquire biometric information included in a captured image captured by a predetermined imaging device;
cause an authentication device that stores biometric information of a plurality of users to perform personal authentication for the acquired biometric information;
acquire, in a case where the personal authentication has succeeded, a purchase history of a user who has succeeded in the personal authentication at a predetermined shop;
estimate a purchase tendency based on the purchase history;
select recommendation information based on the purchase tendency; and
output the selected recommendation information to a predetermined display terminal.

2. The recommendation device according to claim 1,
wherein the at least one processor is further configured to execute the instructions to extract a purchase history of at least one type of product included in the purchase history and estimate a purchase tendency for the product.

3. The recommendation device according to claim 1, wherein the at least one processor is further configured to execute the instructions to;
estimate, as the purchase tendency, a time at which a next purchase of a specific product is to be made by the user based on the purchase history, and
output the selected recommendation information at the time at which the next purchase is to be made.

4. The recommendation device according to claim 3,
wherein the at least one processor is further configured to execute the instructions to output the selected recommendation information in a case where a time at which the user visits the predetermined shop is the time at which the next purchase is to be made.

5. The recommendation device according to claim 1,
wherein the recommendation information is a coupon that is available when a cumulative purchase amount of the user at the predetermined shop is equal to or more than a predetermined amount.

6. The recommendation device according to claim 1, wherein
the predetermined imaging device is installed in the predetermined shop, and
the at least one processor is further configured to execute the instructions to acquire the biometric information when the user visits the predetermined shop.

7. The recommendation device according to claim 1,
wherein the at least one processor is further configured to execute the instructions to output the selected recommendation information when the user visits the predetermined shop.

8. The recommendation device according to claim 1,
wherein the recommendation information is a coupon that is available in the predetermined shop.

9. The recommendation device according to claim 8, wherein
the purchase history includes a purchase amount of the user at the predetermined shop, and
a discount amount of the coupon is determined according to the cumulative purchase amount of the user.

10. The recommendation device according to claim 1, the at least one processor is further configured to execute the instructions to;
acquire personal information of the user,
select the recommendation information based on the personal information and the purchase tendency.

11. The recommendation device according to claim 10,
wherein the personal information includes a birthday of the user.

12. A recommendation system comprising:
an imaging device that captures an image including biometric information of a predetermined user;
a recommendation device that is configured to perform communication with the imaging device; and
an authentication device that stores the biometric information of the user and is configured to perform communication with the recommendation device,
wherein the recommendation device is configured to:
acquire biometric information included in a captured image captured by the imaging device;
cause the authentication device to perform personal authentication for the acquired biometric information;
acquire, in a case where the personal authentication has succeeded, a purchase history of a user who has succeeded in the personal authentication at a predetermined shop;
estimate a purchase tendency based on the purchase history;
select recommendation information based on the purchase tendency; and
output the selected recommendation information to a predetermined display terminal.

13. The recommendation system according to claim 12,
wherein the recommendation device is configured to extract a purchase history of at least one type of product included in the purchase history and estimates a purchase tendency for the product.

14. A recommendation method performed by a computer, the recommendation method comprising:
acquiring biometric information included in a captured image captured by a predetermined imaging device;
causing an authentication device that stores biometric information of a plurality of users to perform personal authentication for the acquired biometric information;
acquiring, in a case where the personal authentication has succeeded, a purchase history of a user who has succeeded in the personal authentication at a predetermined shop;
estimating a purchase tendency based on the purchase history;
selecting recommendation information based on the purchase tendency; and
outputting the selected recommendation information to a predetermined display terminal.

15. A non-transitory computer-readable medium storing a recommendation program that causes a computer to perform:
acquiring biometric information included in a captured image captured by a predetermined imaging device;
causing an authentication device that stores biometric information of a plurality of users to perform personal authentication for the acquired biometric information;
acquiring, in a case where the personal authentication has succeeded, a purchase history of a user who has succeeded in the personal authentication at a predetermined shop;
estimating a purchase tendency based on the purchase history;
selecting recommendation information based on the purchase tendency; and
outputting the selected recommendation information to a predetermined display terminal.

16. A recommendation device comprising:
at least one memory acquiring storing instructions and
at least one processor configured to execute the instructions to;
acquire biometric information included in a captured image captured by a predetermined imaging device;
perform personal authentication using biometric information of a plurality of users stored in advance, for the acquired biometric information;
acquire, in a case where the personal authentication has succeeded, a purchase history of a user who has succeeded in the personal authentication at a predetermined shop;
estimate a purchase tendency based on the purchase history;
select recommendation information based on the purchase tendency; and
output the selected recommendation information to a predetermined display terminal.

17. The recommendation device according to claim 16,
wherein the at least one processor is further configured to execute the instructions to extract a purchase history of at least one type of product included in the purchase history and estimates a purchase tendency for the product.

18. A recommendation method performed by a computer, the recommendation method comprising:
acquiring biometric information included in a captured image captured by a predetermined imaging device;
performing personal authentication using biometric information of a plurality of users stored in advance, for the acquired biometric information;
acquiring, in a case where the personal authentication has succeeded, a purchase history of a user who has succeeded in the personal authentication at a predetermined shop;
estimating a purchase tendency based on the purchase history;
selecting recommendation information based on the purchase tendency; and
outputting the selected recommendation information to a predetermined display terminal.

19. A non-transitory computer-readable medium storing a recommendation program that causes a computer to perform:
acquiring biometric information included in a captured image captured by a predetermined imaging device;
performing personal authentication using biometric information of a plurality of users stored in advance, for the acquired biometric information;
acquiring, in a case where the personal authentication has succeeded, a purchase history of a user who has succeeded in the personal authentication at a predetermined shop;
estimating a purchase tendency based on the purchase history;
selecting recommendation information based on the purchase tendency; and
outputting the selected recommendation information to a predetermined display terminal.
